(19) United States
(12) Patent Application Publication
(10) Pub. No.: US 2025/0266626 A1
(43) Pub. Date: Aug. 21, 2025

(54) Bus Bar Connection Structure

(71) Applicant: Yazaki Corporation, Tokyo (JP)

(72) Inventors: Hiroyuki Tanaka, Kakegawa-shi (JP); Takanori Kanamori, Kakegawa-shi (JP)

(21) Appl. No.: 19/204,465

(22) Filed: May 9, 2025

Related U.S. Application Data
(63) Continuation of application No. PCT/JP2023/040659, filed on Nov. 10, 2023.

(30) Foreign Application Priority Data
Dec. 12, 2022 (JP) 2022-197910

(51) Int. Cl. H01R 4/58; H01M 50/503; H01M 50/507; H01M 50/516; H01R 4/02

(52) U.S. Cl. CPC H01R 4/58; H01M 50/503; H01M 50/507; H01M 50/516; H01R 4/029; H01M 2220/20; H01R 2201/26

(57) ABSTRACT

A busbar coupling structure includes a first busbar and a second busbar. The first busbar includes a first body portion extending in a front-rear direction, and has a recessed portion that is recessed in the front-rear direction at one end portion of the first body portion in the front-rear direction. The second busbar includes a second body portion extending in an oblique direction relative to the front-rear direction, and has a protruding portion that protrudes in the oblique direction from one end portion of the second body portion in the oblique direction. The recessed portion and the protruding portion have such shapes that allow the second busbar to rotate relatively to the first busbar around the protruding portion as an axis in a plane that includes the front-rear direction and the oblique direction. The recessed portion and the protruding portion are joined to each other.

### CROSS-REFERENCE TO RELATED APPLICATIONS

This is a continuation of International Application No. PCT/JP2023/040659 filed on Nov. 10, 2023, and claims priority from Japanese Patent Application No. 2022-197910 filed on Dec. 12, 2022, the entire content of which is incorporated herein by reference.

### TECHNICAL FIELD

The present invention relates to a busbar coupling structure.

### BACKGROUND ART

In a battery pack mounted on an electric automobile or a hybrid automobile that travels using an electric motor, a busbar is used for connecting electrodes of a plurality of cells (for example, see Patent Literature 1).

As an example of wiring a busbar, which is a flat rectangular metal conductor, in an oblique direction, in a busbar coupling structure 101 shown in FIG. 7, a busbar 112 having an inclined end face in accordance with a wiring direction is disposed between linearly extending busbars 110 and 113, and the busbars are joined together. In addition, as another example, in a busbar coupling structure 101A shown in FIG. 8, an upper face of a busbar 122 disposed in accordance with a wiring direction is joined to lower faces of busbars 121 and 123 extending linearly.

### CITATION LIST

### Patent Literature

Patent Literature 1: JP2017-4744A

### SUMMARY OF INVENTION

However, in the busbar coupling structure 101 shown in FIG. 7, since a joint angle is different for each wiring direction and an inclination angle of the end face of the busbar 112 needs to be different, versatility is low. Further, in the busbar coupling structure 101A shown in FIG. 8, since the busbars are joined to each other on the upper and lower faces, a space in a thickness (plate thickness) direction is required. Further, in the busbar coupling structure described in Patent Literature 1, since the busbars are connected to each other via a hinge portion and the hinge portion has a cylindrical portion formed by bending an end portion of each busbar into a cylindrical shape, a space of the cylindrical portion is required in addition to a plate thickness of the busbars.

The present invention has been made in view of the above-described circumstances, and an object thereof is to provide a busbar coupling structure that can improve versatility and save space.

In order to achieve the object described above, the busbar coupling structure according to the present invention is characterized as follows.

A busbar coupling structure including:
a first busbar having a first body portion extending in a first direction, and a recessed portion that is recessed in the first direction at one end portion of the first body portion in the first direction; and
a second busbar having a second body portion extending in a second direction, and a protruding portion that protrudes in the second direction from one end portion of the second body portion in the second direction, in which
the recessed portion and the protruding portion have such shapes that allow the second busbar to rotate relatively to the first busbar around the protruding portion as an axis in a plane that includes the first direction and the second direction, and
the recessed portion and the protruding portion are jointed to each other.

According to the present invention, it is possible to provide a busbar coupling structure that can improve versatility and save space.

The present invention has been briefly described above. Further, the details of the present invention can be clarified by reading a mode (hereinafter, referred to as an “embodiment”) for carrying out the invention to be described below with reference to the accompanying drawings.

### BRIEF DESCRIPTION OF DRAWINGS

FIG. 1 is a perspective view showing a busbar coupling structure according to a first embodiment;

FIG. 2 is an exploded perspective view of the busbar coupling structure shown in FIG. 1;

FIG. 3 is an enlarged top view of a part of the busbar coupling structure shown in FIG. 1;

FIG. 4 is a perspective view showing a busbar coupling structure according to a second embodiment;

FIG. 5 is an exploded perspective view of the busbar coupling structure shown in FIG. 4;

FIG. 6 is an enlarged top view of a part of the busbar coupling structure shown in FIG. 4;

FIG. 7 is a perspective view showing an example of a busbar coupling structure in the related art; and

FIG. 8 is a perspective view showing another example of a busbar coupling structure in the related art.

### DESCRIPTION OF EMBODIMENTS

Specific embodiments of the present invention will be described below with reference to the drawings.

### First Embodiment

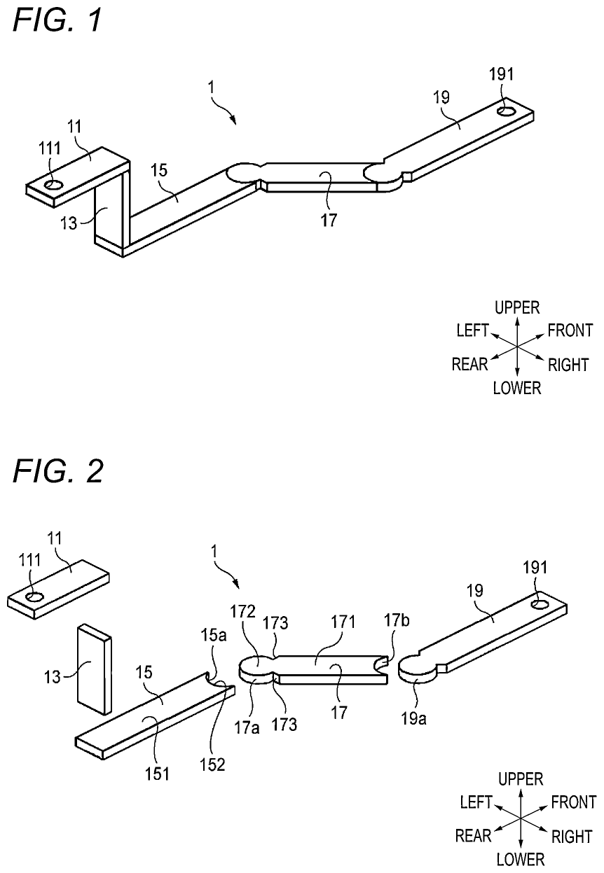

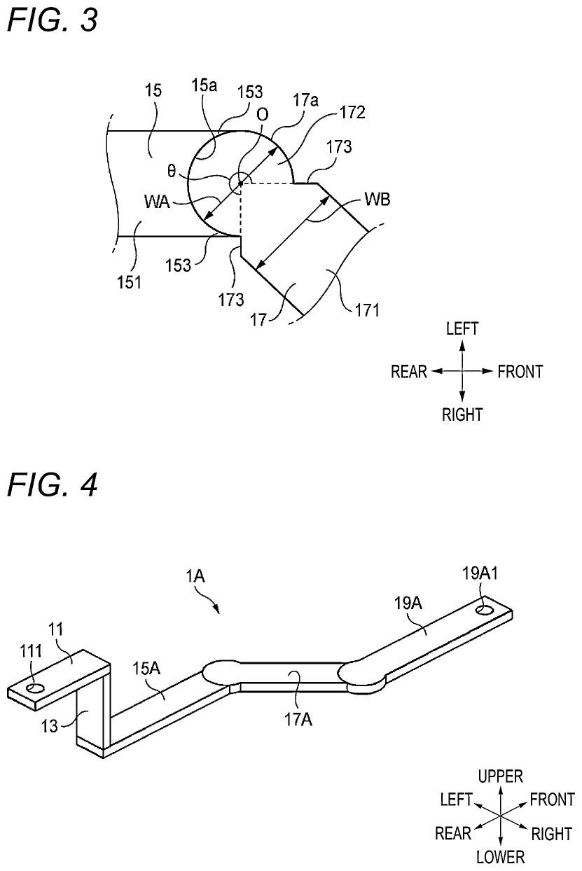

FIG. 1 is a perspective view showing a busbar coupling structure 1 according to a first embodiment. FIG. 2 is an exploded perspective view of the busbar coupling structure 1 shown in FIG. 1. FIG. 3 is an enlarged top view of a part of the busbar coupling structure 1 shown in FIG. 1. Hereinafter, for convenience of description, as shown in FIG. 1, a “front-rear direction”, a “left-right direction”, and an “upper-lower direction” are defined. The “front-rear direction”, the “left-right direction”, and the “upper-lower direction” are orthogonal to one another. The front-rear direction is an example of a first direction.

The busbar coupling structure 1 is to be assembled between components and/or devices of an automobile and used for electrical connections within a battery pack that is used as a power supply to drive a motor of a vehicle, for example. The busbar coupling structure 1 is a busbar for supplying vehicle driving power, that is, a high-voltage busbar.

The busbar coupling structure 1 includes a busbar 11, a busbar 13, a busbar 15, a busbar 17, and a busbar 19. As described below, adjacent busbars are joined together by, for example, laser welding. The busbar 15 is an example of a first busbar, and the busbar 17 is an example of a second busbar.

Each of the busbars 11, 13, 15, and 17 is formed by punching a conductive metal plate having a predetermined thickness, and has a flat rectangular parallelepiped shape. The busbars 11, 15, and 19 extend in the front-rear direction. The busbar 13 extends in the upper-lower direction. The busbar 17 extends in an oblique direction inclined at a predetermined angle with respect to the front-rear direction. The oblique direction is an example of a second direction. The busbar 11 has a through hole 111 at a rear end portion for attachment to a component, and a front end portion thereof is joined to an upper end face of the busbar 13. A lower end face of the busbar 13 is joined to an upper face of a rear end portion of the busbar 15.

The busbar 15 includes a body portion 151 extending in the front-rear direction, and a recessed portion 152 that is recessed in the front-rear direction at one end portion, that is, a front end portion of the body portion 151 in the front-rear direction. The body portion 151 is an example of a first body portion. The busbar 17 includes a body portion 171 extending in the oblique direction, and a protruding portion 172 that protrudes in the oblique direction from one end portion, that is, a rear end portion of the body portion 171 in the oblique direction. The recessed portion 152 and the protruding portion 172 have such shapes that allow the busbar 17 to rotate relatively to the busbar 15 around the protruding portion 172 as an axis in a horizontal plane, that is, a plane that includes the front-rear direction and the oblique direction. The recessed portion 152 and the protruding portion 172 are joined together.

The recessed portion 152 has a concave arc-shaped end face 15a. The protruding portion 172 has a convex arc-shaped end face 17a corresponding to the concave arc shape of the end face 15a. The end face 15a is an example of a first end face, and the end face 17a is an example of a second end face. The recessed portion 152 and the protruding portion 172 have respective concave and convex arc-shaped end faces 15a and 17a having substantially the same diameter dimension, and are therefore rotatable in a state of abutting against each other. The concave and convex arc-shaped end faces 15a, 17a are configured such that a diameter of the convex arc-shaped end face 17a is slightly smaller than that of the concave arc-shaped end face 15a. Therefore, the busbar 15 and the busbar 17 can be coupled such that the body portions 151 and 171 are arranged at a predetermined angle in a state where the end faces 15a and 17a are abutting against each other.

In the busbar coupling structure 1, the recessed portion 152 and the protruding portion 172 have such shapes that allow the busbar 17 to rotate relatively to the busbar 15 around the protruding portion 172 as an axis in a horizontal plane, that is, a plane that includes the front-rear direction and the oblique direction, and the recessed portion 152 and the protruding portion 172 are joined together. According to this configuration, a coupling angle between the busbar 15 and the busbar 17 can be adjusted, so that the versatility of the busbar coupling structure 1 can be improved. In addition, since the busbar 15 and the busbar 17 are connected in the same plane, it is possible to reduce a space in the thickness (plate thickness) direction, that is, the upper-lower direction, as compared with a case where the busbar 15 and the busbar 17 are connected in an overlapping manner. Further, the busbar 15 and the busbar 17 are joined to each other by the arcuate faces, so that a joining area is large and stable conduction is enabled.

A recessed portion similar to the recessed portion 152 of the busbar 15 is provided on a front end portion of the busbar 17. The busbar 19 is provided with a protruding portion similar to the protruding portion 172 of the busbar 17 at a rear end portion, and has a through hole 191 for attachment to a component at a front end portion. The recessed portion and the protruding portion have such shapes that allow the busbar 19 to rotate relatively to the busbar 17 around the protruding portion as an axis in the horizontal plane. Accordingly, a coupling angle between the busbar 17 and the busbar 19 can be adjusted. The busbar 17 and the busbar 19 are arranged such that the body portions 151 and 171 are at a predetermined angle, and the recessed portion 152 and the protruding portion 172 are joined to each other. By joining the busbar 17 and the busbar 19 in this manner, it is possible to reduce the space in the thickness direction as compared with the case where the busbar 17 and the busbar 19 are connected in an overlapping manner. The busbar 17 is an example of the first busbar, and the busbar 19 is an example of the second busbar.

As shown in FIG. 3, the convex arc-shaped end face 17a of the busbar 17 has an arc width WA that is equal to or smaller than a width WB that is the dimension of the body portion 171 in a width direction, and an arc opening angle θ, which is an angle around a center point O, is approximately 270 degrees. As shown in FIG. 3, the busbar 17 has a notch 173 between the body portion 171 and the end face 17a. By providing the notch 173, a length of the convex arc of the end face 17a, that is, a length of the end face 17a in the horizontal plane can be increased, and the busbar 17 becomes rotatable relative to busbar 15 to a position where a tip portion 153 comes into contact with the notch 173. That is, a rotatable range of the busbar 17 relative to the busbar 15 can be increased. Accordingly, the versatility of the busbar coupling structure 1 can be improved. The tip portion 153 is formed by the left and right side faces at the front end portion of the body portion 151 of the busbar 15 and the left and right end portions of the recessed portion 152. The notch 173 is formed in a shape and size capable of receiving the tip portion 153. Since the end face 17a has an arc opening angle θ of 225 degrees or more and 315 degrees or less, the rotatable range of the busbar 17 relative to the busbar 15 can be increased, and the strength of the connection between the protruding portion 172 and the body portion 171 via the notch 173 can be ensured.

The busbar coupling structure 1 configured as described above is formed by joining the busbar 11, the busbar 15, the busbar 17, and the busbar 19 together. In the busbar coupling structure 1, the busbar 11 and the busbar 19 are attached to various components through the through hole 111 and the through hole 191, respectively, to enable electrical continuity between the components. At a butt joint portion between adjacent busbars among the busbars 15, 17, and 19, one busbar has the convex arc-shaped end face 17a, 19a, while the other busbar has the concave arc-shaped end face 15a, 17b that has substantially the same diameter as the convex arc. Since the joining faces of the busbars 15, 17, and 19 have an arc shape, there is no need to provide inclined end faces with different angles according to the wiring direction, and the busbars can be joined in various directions on the arc. As described above, in the busbar coupling structure 1, since the busbars are joined to each other by the arcuate faces, a rotation direction can be freely adjusted for joining, so that the busbar can be attached to components with different paths, and the versatility is improved. Further, in the busbar coupling structure 1, since the busbars are joined to each other by the arcuate faces, the joining area is larger than that of a normal butt joint, and stable conduction is enabled.

### Second Embodiment

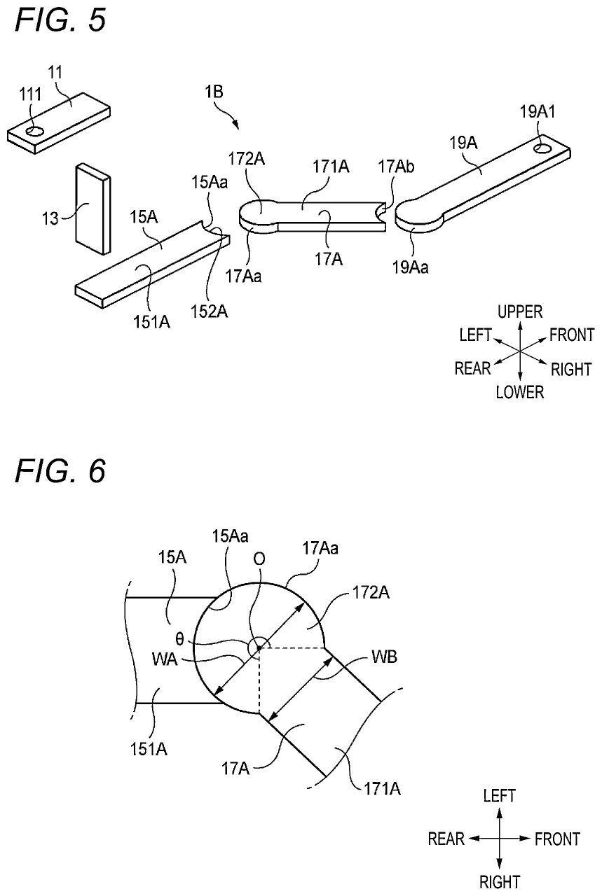

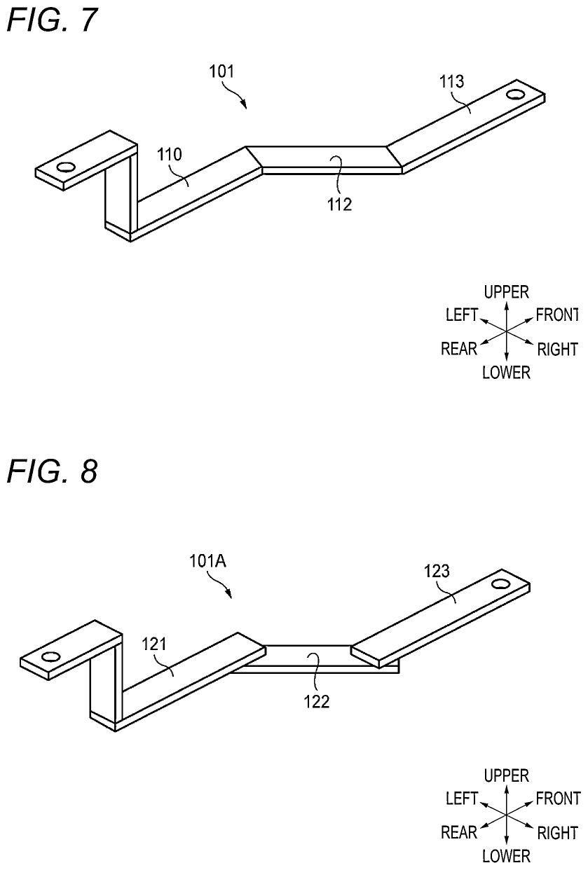

FIG. 4 is a perspective view showing a busbar coupling structure according to a second embodiment. FIG. 5 is an exploded perspective view of the busbar coupling structure shown in FIG. 4. FIG. 6 is an enlarged top view of a part of the busbar coupling structure shown in FIG. 4. Hereinafter, for convenience of description, as shown in FIG. 5, a “front-rear direction”, a “left-right direction”, and an “upper-lower direction” are defined. The “front-rear direction”, the “left-right direction”, and the “upper-lower direction” are orthogonal to one another. In the second embodiment, the same members and portions as those shown in FIGS. 1 to 4 are denoted by the same reference numerals, and redundant description thereof will be omitted.

A busbar coupling structure 1A includes busbars 15A, 17A, and 19A as shown in FIG. 4, instead of the busbars 15, 17, and 19 in the busbar coupling structure 1 shown in FIGS. 1 to 3.

The busbar 15A includes a body portion 151A extending in the front-rear direction, and a recessed portion 152A that is recessed in the front-rear direction at one end portion, that is, a front end portion of the body portion 151A in the front-rear direction. The body portion 151A is an example of the first body portion. The busbar 17A includes a body portion 171A extending in the oblique direction, and a protruding portion 172A that protrudes in the oblique direction from one end portion, that is, a rear end portion of the body portion 171A in the oblique direction. The recessed portion 152A and the protruding portion 172A have such shapes that allow the busbar 17A to rotate relatively to the busbar 15A around the protruding portion 172A as an axis in a horizontal plane, that is, a plane that includes the front-rear direction and the oblique direction. The recessed portion 152A and the protruding portion 172A are joined together.

The recessed portion 152A has a concave arc-shaped end face 15Aa. The protruding portion 172A has a convex arc-shaped end face 17Aa corresponding to the concave arc shape of the end face 15Aa. The end face 15Aa is an example of the first end face, and the end face 17Aa is an example of the second end face. The recessed portion 152A and the protruding portion 172A have respective concave and convex arc-shaped end faces 15Aa and 17Aa having substantially the same diameter dimension as the convex arc, and are therefore rotatable in a state of abutting against each other. The concave and convex arc-shaped end faces 15Aa, 17Aa are configured such that a diameter of the convex arc-shaped end face 17Aa is slightly smaller than that of the concave arc-shaped end face 15Aa. Therefore, the busbar 15A and the busbar 17A can be coupled such that the body portions 151A and 171A are arranged at a predetermined angle in a state where the end faces 15Aa and 17Aa are abutting against each other.

In the busbar coupling structure 1A, the recessed portion 152A and the protruding portion 172A have such shapes that allow the busbar 17A to rotate relatively to the busbar 15A around the protruding portion 172A as an axis in a horizontal plane, that is, a plane that includes the front-rear direction and the oblique direction, and the recessed portion 152A and the protruding portion 172A are joined together. According to this configuration, a coupling angle between the busbar 15A and the busbar 17A can be adjusted, so that the versatility of the busbar coupling structure 1A can be improved. In addition, since the busbar 15A and the busbar 17A are connected in the same plane, it is possible to reduce a space in the thickness direction, that is, the upper-lower direction, as compared with a case where the busbar 15A and the busbar 17A are connected in an overlapping manner. Further, the busbar 15A and the busbar 17A are joined to each other by the arcuate faces, so that a joining area is large and stable conduction is enabled.

A recessed portion similar to the recessed portion 152A of the busbar 15A is provided on a front end portion of the busbar 17A. The busbar 19A is provided with a protruding portion similar to the protruding portion 172A of the busbar 17A at a rear end portion, and has a through hole 19A1 for attachment to a component at a front end portion. The recessed portion and the protruding portion have such shapes that allow the busbar 19A to rotate relatively to the busbar 17A around the protruding portion as an axis in the horizontal plane. Accordingly, a coupling angle between the busbar 17A and the busbar 19A can be adjusted. The busbar 17A and the busbar 19A are arranged such that the body portions 151A and 171A are at a predetermined angle, and the recessed portion 152A and the protruding portion 172A are joined to each other. By joining the busbar 17A and the busbar 19A in this manner, it is possible to reduce the space in the thickness direction as compared with the case where the busbar 17A and the busbar 19A are connected in an overlapping manner. The busbar 17A is an example of the first busbar, and the busbar 19A is an example of the second busbar.

As shown in FIG. 6, the convex arc-shaped end face 17Aa of the busbar 17A has an arc width WA that is greater than the width WB that is the dimension of the body portion 171A in the width direction, and an arc opening angle θ, which is an angle around a center point O, is approximately 270 degrees. Since the arc width WA of the end face 17Aa is greater than the width WB of the body portion 171A, a rotatable range of the busbar 17A relative to the busbar 15A is increased. Accordingly, the versatility of the busbar coupling structure 1A can be improved. Since the end face 17Aa has an arc opening angle θ of 225 degrees or more and 315 degrees or less, the rotatable range of the busbar 17A relative to the busbar 15A can be sufficiently increased, which is advantageous in practical use.

The busbar coupling structure 1A configured as described above is formed by joining the busbar 11, the busbar 15A, the busbar 17A, and the busbar 19A together. In the busbar coupling structure 1A, the busbar 11 and the busbar 19A are attached to various components through the through hole 111 and the through hole 19A1, respectively, to enable electrical continuity. At a butt joint portion between adjacent busbars among the busbars 15A, 17A, and 19A, one busbar has the end face 17Aa, 19Aa each having a convex arc shape with a diameter larger than the width of the busbar body portion, while the other busbar has the concave arc-shaped end face 15Aa, 17Ab that has substantially the same diameter as the convex arc. Since the joining faces of the busbars 15A, 17A, and 19A have an arc shape, there is no need to provide inclined end faces with different angles according to the wiring direction, and the busbars can be joined in various directions on the arc. As described above, in the busbar coupling structure 1A, since the busbars are joined to each other by the arcuate faces, a rotation direction can be freely adjusted for joining, so that the busbar can be attached to components with different paths, and the versatility is improved. Further, in the busbar coupling structure 1A, since the busbars are joined to each other by the arcuate faces, the joining area is larger than that of a normal butt joint, and stable conduction is enabled.

The present invention is not limited to the above-described embodiments, and can be appropriately modified, improved, or the like. In addition, the material, shape, size, numerical value, form, number, arrangement position, and the like of components in the above-described embodiments are freely selected and are not limited as long as the present invention can be achieved. In each of the above-described embodiments, the one end face 17a, 17Aa of the busbar 17, 17A has a convex arc shape and the other end face 17b, 17Ab of the busbar 17, 17A has a concave arc shape. Alternatively, both end faces may have a convex arc shape, or both end faces may have a concave arc shape.

Further, in each of the above-described embodiments, the recessed portion 152, 152A of the busbar 15, 15A and the protruding portion 172, 172A of the busbar 17, 17A are joined by the concave arc-shaped end face 15a, 15Aa and the convex arc-shaped end face 17a, 17Aa. However, the shapes of the recessed portion and the protruding portion are not limited to arc shapes. The recessed portion and protruding portion may have any shape that allows one busbar to rotate relative to the other busbar in a horizontal plane, and may be, for example, a polygonal or gear shape.

Here, features of the busbar coupling structure according to the embodiments of the present invention described above are briefly summarized and listed in the following [1] to [5].

[1] A busbar coupling structure (1, 1A) including:
a first busbar (busbar 15) having a first body portion (body portion 151) extending in a first direction (front-rear direction), and a recessed portion (152) that is recessed in the first direction at one end portion of the first body portion in the first direction; and
a second busbar (busbar 17) having a second body portion (body portion 171) extending in a second direction, and a protruding portion (172) that protrudes in the second direction from one end portion of the second body portion in the second direction, in which
the recessed portion and the protruding portion have such shapes that allow the second busbar to rotate relatively to the first busbar around the protruding portion as an axis in a plane that includes the first direction and the second direction, and
the recessed portion and the protruding portion are jointed to each other.

According to the busbar coupling structure having the configuration of the above [1], the recessed portion and the protruding portion have such shapes that allow the second busbar to rotate relatively to the first busbar around the protruding portion as an axis in the plane that includes the first direction and the second direction, and the recessed portion and the protruding portion are jointed to each other. According to this configuration, a coupling angle between the first busbar and the second busbar can be adjusted, so that the versatility of the busbar coupling structure can be improved. In addition, since the first busbar and the second busbar are connected in the same plane, it is possible to reduce a space in the thickness direction as compared with a case where the first busbar and the second busbar are connected in an overlapping manner.

[2] In the busbar coupling structure according to [1],
the recessed portion (152) has a first end face (end face 15a, 15Aa) having a concave arc shape, and
the protruding portion (172) has a second end face (end face 17a, 17Aa) having a convex arc shape corresponding to the concave arc shape.

According to the busbar coupling structure having the configuration of the above [2], since the first busbar and the second busbar are joined to each other by the arcuate faces, the joining area is large and stable conduction is enabled.

[3] In the busbar coupling structure according to [2],
the second end face (end face 17a) has an arc width (WA) equal to or smaller than a dimension (width WB) of the second body portion (body portion 171) in a width direction intersecting the second direction, and an arc opening angle (0) of 225 degrees or more and 315 degrees or less, and
the second busbar (busbar 17) has a notch between the second body portion and the second end face.

According to the busbar coupling structure having the configuration of the above [3], since the second busbar has the notch between the second body portion and the second end face, a length of the convex arc of the second end face can be increased, and the second busbar can rotate relative to the first busbar to a position where a tip portion of the first busbar comes into contact with the notch. That is, a rotatable range of the second busbar relative to the first busbar can be increased. Accordingly, the versatility can be improved. Further, the arc opening angle is 225 degrees or more and 315 degrees or less, so that the rotatable range of the second busbar relative to the first busbar can be increased, and the strength of the connection between the protruding portion and the second body portion via the notch can be ensured.

[4] In the busbar coupling structure according to [2],
an arc width (WA) of the second end face is larger than a dimension (width WB) of the second body portion in a width direction intersecting the second direction.

According to the busbar coupling structure having the configuration of the above [4], since the arc width of the second end face having the convex arc shape is larger than the width of the second body portion, the rotatable range of the second busbar relative to the first busbar can be increased. Accordingly, the versatility can be improved.

[5] In the busbar coupling structure according to any one of [1] to [4],
the first busbar and the second busbar are busbars for supplying vehicle driving power.

According to the busbar coupling structure having the configuration of the above [5], the busbar coupling structure can be used, for example, for electrical connection in a high-voltage battery pack mounted on a vehicle.

The present application is based on a Japanese patent application (Japanese Patent Application No. 2022-197910) filed on Dec. 12, 2022, and the contents thereof are incorporated herein by reference.

### Industrial Applicability

According to the present invention, it is possible to provide a busbar coupling structure that can improve versatility and save space. The present invention having this effect is useful in relation to a busbar coupling structure.

What is claimed is:

1. A busbar coupling structure comprising:
a first busbar having a first body portion extending in a first direction, and a recessed portion that is recessed in the first direction at one end portion of the first body portion in the first direction; and
a second busbar having a second body portion extending in a second direction, and a protruding portion that protrudes in the second direction from one end portion of the second body portion in the second direction,
wherein the recessed portion and the protruding portion have such shapes that allow the second busbar to rotate relatively to the first busbar around the protruding portion as an axis in a plane that includes the first direction and the second direction, and
wherein the recessed portion and the protruding portion are jointed to each other.

2. The busbar coupling structure according to claim 1,
wherein the recessed portion has a first end face having a concave arc shape, and
wherein the protruding portion has a second end face having a convex arc shape corresponding to the concave arc shape.

3. The busbar coupling structure according to claim 2,
wherein the second end face has an arc width equal to or smaller than a dimension of the second body portion in a width direction intersecting the second direction, and an arc opening angle of 225 degrees or more and 315 degrees or less, and
wherein the second busbar has a notch between the second body portion and the 25 second end face.

4. The busbar coupling structure according to claim 2,
wherein an arc width of the second end face is larger than a dimension of the second body portion in a width direction intersecting the second direction.

5. The busbar coupling structure according to claim 1,
wherein the first busbar and the second busbar are busbars for supplying vehicle driving power.
